(19) United States
(12) Patent Application Publication
(10) Pub. No.: US 2026/0360611 A1
(43) Pub. Date: Nov. 12, 2026

(54) COUPLED INDUCTOR

(71) Applicant: CYNTEC CO., LTD., Hsinchu (TW)

(72) Inventors: Wei-Lun Huang, Hsinchu (TW); SEN-HUEI CHEN, Hsinchu (TW); Chi-Cheng Ma, Hsinchu (TW)

(21) Appl. No.: 19/747,159

(22) Filed: Jul. 20, 2026

Related U.S. Application Data
(62) Division of application No. 17/854,001, filed on Jun. 30, 2022, now Pat. No. 12,706,240.
(60) Provisional application No. 63/217,760, filed on Jul. 1, 2021.
(60) Provisional application No. 63/251,047, filed on Oct. 1, 2021.

(51) Int. Cl. H01F 27/29; H01F 27/24; H01F 27/28

(52) U.S. Cl. CPC H01F 27/29; H01F 27/24; H01F 27/2823

(57) ABSTRACT

A coupled inductor having a body, wherein a first electrode and a second electrode are connected to a first coil, and a third electrode and a fourth electrode are connected to a second coil, wherein a first horizontal line segment passing through the first electrode and the second electrode and a second horizontal line segment passing through the third electrode and the fourth electrode crosses each other at a location inside the periphery of a bottom surface of the body.

### CROSS-REFERENCES TO RELATED APPLICATIONS

This application is a divisional application of U.S. Patent Application No. 17/854,001, filed on Jun. 30, 2022, which claims the benefit of U.S. Provisional Patent Application No. 63/217,760 filed on Jul. 01, 2021 and U.S. Provisional Patent Application No. 63/251,047 filed on Oct. 01, 2021. The contents of U.S. Patent Application No. 17/854,001, U.S. Provisional Patent Application No. 63/217,760, and U.S. Provisional Patent Application No. 63/251,047 are hereby incorporated by reference herein in their entireties and made a part of the specification.

### BACKGROUND OF THE INVENTION

### I.Field of the Invention

The present invention relates to a coupled inductor, and in particular to, an coupled inductor with higher coupling efficiency.

### II.Description of Related Art

A conventional coupled inductor with inner and outer leads will cause leakage inductance which will reduce the K value. In addition, the gap the main coil and the secondary coil of the conventional coupled inductor will lead to leakage inductance as well. The leakage inductance will reduce coupling efficiency (K) of the coupled inductor.

Furthermore, the electrodes structure of a conventional coupled inductor will cause the layout of a circuit containing multiple coupled inductors difficult for routing wires.

Therefore, a better solution is needed to resolve the above-mentioned issues.

### SUMMARY OF THE INVENTION

The present invention provides a coupled inductor having a first electrode and a second electrode electrically connected to the first conductive wire as well as a third electrode and a fourth electrically connected to the second conductive wire, wherein a first horizontal line segment passing through the first electrode and the second electrode and a second horizontal line segment passing through the third electrode and the fourth electrode crosses each other at a location inside the periphery of the first surface of the body for making a layout of a circuit containing multiple coupled inductors easier for routing wires.

The present invention provides a coupled inductor comprising a first coil and a second coil, wherein the winding turns of the first coil is interleaved with the winding turns of the second coil for increasing the coupling efficiency of the coupled inductor.

The present invention provides a coupled inductor comprising a first conductive wire and a second conductive wire, wherein the at least one first winding turn of the first conductive wire and the at least one second winding turn of the second conductive wire are encapsulated by a magnetic portion of the body, and a first terminal part of the second conductive wire is encapsulated by a non-magnetic portion of the body for increasing the coupling efficiency of the coupled inductor.

In one embodiment, a coupled inductor is disclosed, wherein the coupled inductor comprises: a body; a first conductive wire; and a second conductive wire; wherein at least one portion of the first conductive wire and at least one portion of the second conductive wire are disposed inside the body; a first electrode, a second electrode, a third electrode, and a fourth electrode, wherein the first electrode, the second electrode, the third electrode, and the fourth electrode are disposed on a first surface of the body, wherein the first electrode and the second electrode are electrically connected to the first conductive wire, and the third electrode and the fourth electrode are electrically connected to the second conductive wire, wherein two end points of a first horizontal line segment are respectively passing through the first electrode and the second electrode; and two end points of a second horizontal line segment are respectively passing through the third electrode and the fourth electrode, wherein the first horizontal line segment and the second horizontal line segment crosses each other at a location inside the periphery of the first surface of the body.

In one embodiment, the first conductive wire comprises a first coil comprising at least one first winding turn and a second coil comprising at least one second winding turn, wherein the at least one first winding turn of the first conductive wire and the at least one second winding turn of the second conductive wire are disposed inside the body.

In one embodiment, the first horizontal line segment is perpendicular to the second horizontal line segment.

In one embodiment, a first thickness of the first conductive wire is greater than a second thickness of the second conductive wire.

In one embodiment, a first portion of the at least one second winding turn of a second conductive wire is disposed between a second portion of the first conductive wire and a third portion of the first conductive wire.

In one embodiment, said first portion, said second portion, and said third portion are stacked along a vertical direction.

In one embodiment, the at least one first winding turn of the first conductive wire and the at least one second winding turn of the second conductive wire are encapsulated by the magnetic portion of the body, and a first terminal part of the second conductive wire is encapsulated by the non-magnetic portion of the body.

In one embodiment, the first electrode extends from a first edge to a second edge of the bottom surface of the body, and the second electrode extends from the first edge to the second edge of the bottom surface of the body, wherein said first edge and said second edge are two opposite edges of the bottom surface of the body, wherein the third electrode extends from a first edge to a second edge of the bottom surface of the body, wherein the third electrode is disposed along a third edge of the bottom surface of the body and the fourth electrode is disposed along a fourth edge of the bottom surface, wherein said third edge and said fourth edge are two opposite edges of the bottom surface of the body.

In one embodiment, the body comprises a magnetic body.

In one embodiment, the magnetic body comprises a T core, wherein the first coil and the second coil are wound around a pillar of the T core.

In one embodiment, an adhesive material is disposed in a space formed by a first winding turn of the first conductive wire and a second winding turn of the second conductive wire.

In one embodiment, a first lead is embedded inside the body with at least one portion of the lead exposed from the bottom surface of the body to form the first electrode.

In one embodiment, a first lead is embedded inside the body with at least one portion of the lead exposed from the bottom surface of the body to form the first electrode.

In one embodiment, a coupled inductor is disclosed, wherein the coupled inductor comprises: a body; a first coil, comprising at least one first winding turn of a first conductive wire; and a second coil, comprising at least one second winding turn of a second conductive wire; wherein the at least one first winding turn of the first conductive wire and the at least one second winding turn of the second conductive wire are disposed inside the body, wherein a first portion of the at least one second winding turn of a second conductive wire is disposed between a second portion of the first conductive wire and a third portion of the first conductive wire, wherein said first portion, said second portion, and said third portion are stacked along a vertical direction.

In one embodiment, a coupled inductor is disclosed, wherein the coupled inductor comprises: a body, comprising a magnetic portion and a non-magnetic portion; a first coil, comprising at least one first winding turn of a first conductive wire; and a second coil, comprising at least one second winding turn of a second conductive wire, wherein the at least one first winding turn of the first conductive wire and the at least one second winding turn of the second conductive wire are encapsulated by the magnetic portion of the body, and a first terminal part of the second conductive wire is encapsulated by the non-magnetic portion of the body.

In one embodiment, a coupled inductor is disclosed, wherein the coupled inductor comprises: a body; a first coil, comprising at least one first winding turn of a first conductive wire; and a second coil, comprising at least one second winding turn of a second conductive wire; wherein the at least one first winding turn of the first conductive wire and the at least one second winding turn of the second conductive wire are disposed inside the body; a first electrode, a second electrode, a third electrode, and a fourth electrode, wherein the first electrode, the second electrode, the third electrode, and the fourth electrode are disposed on a bottom surface of the body, wherein the first electrode and the second electrode are electrically connected to the first coil, and the third electrode and the fourth electrode are electrically connected to the second coil, wherein a first portion of the first lead is embedded inside the body with said first portion of the lead exposed from the bottom surface of the body to form the first electrode, wherein a second portion of the first lead is embedded inside the body, wherein the second portion of the first lead comprises a through opening and a portion of the body is disposed in the through opening.

In one embodiment, a coupled inductor is disclosed, wherein the coupled inductor comprises: a body; a first coil, comprising at least one first winding turn of a first conductive wire; and a second coil, comprising at least one second winding turn of a second conductive wire; wherein the at least one first winding turn of the first conductive wire and the at least one second winding turn of the second conductive wire are disposed inside the body; a first electrode, a second electrode, a third electrode, and a fourth electrode, wherein the first electrode and the second electrode are electrically connected to the first coil, and the third electrode and the fourth electrode are electrically connected to the second coil, wherein a lead is electrically connected to the third electrode, wherein a through hole is formed in the lead, wherein a soldering material is disposed on a top surface of the first portion of the lead and extends to a terminal part of an internal conductor of the second conductive wire via the through hole.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention, the drawings are briefly described as follows.

FIG. 1A shows a perspective view of a coupled inductor according to one embodiment of the present invention;

FIG. 1B shows a side view of a coupled inductor according to one embodiment of the present invention;

FIG. 1C shows a side view of a terminal part of a first conductive wire of a coupled inductor according to one embodiment of the present invention;

FIG. 1D shows a side view of coils structure of a coupled inductor according to one embodiment of the present invention;

FIG. 1E shows a perspective view of a coupled inductor according to one embodiment of the present invention;

FIG. 1F shows current flows of a coupled inductor according to one embodiment of the present invention;

FIG. 1G shows electrodes structure of a coupled inductor according to one embodiment of the present invention;

FIG. 1H shows a placement with multiple coupled inductors according to one embodiment of the present invention;

FIG. 1I shows a top view of a coupled inductor according to one embodiment of the present invention;

FIG. 1J shows a top view of a coupled inductor according to one embodiment of the present invention;

FIG. 1K shows a perspective view of a coupled inductor according to one embodiment of the present invention;

FIG. 1L shows a perspective view of a coupled inductor according to one embodiment of the present invention;

FIG. 1M shows a perspective view of a coupled inductor according to one embodiment of the present invention;

FIG. 2A shows a perspective view of a coupled inductor according to one embodiment of the present invention;

FIG. 2B shows a perspective view of a coupled inductor according to one embodiment of the present invention;

FIG. 2C shows a perspective view of a coupled inductor according to one embodiment of the present invention;

FIG. 2D shows a side view of a soldering structure of electrodes of a coupled inductor according to one embodiment of the present invention; and

FIG. 2E shows a side view of a soldering structure of electrodes of a coupled inductor according to one embodiment of the present invention.

### DESCRIPTION OF EMBODIMENTS

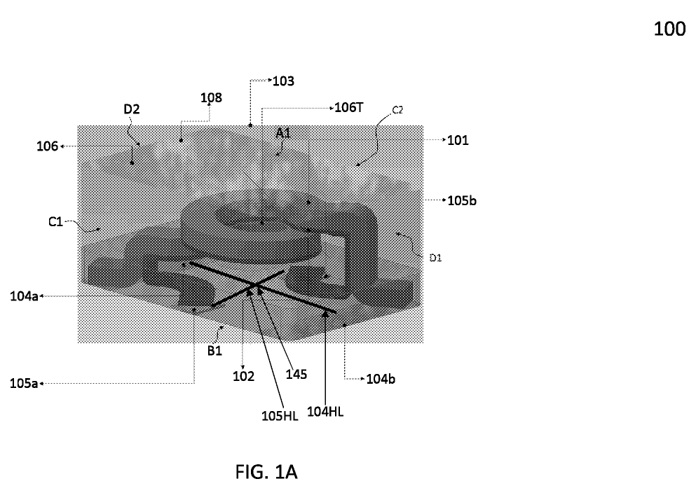

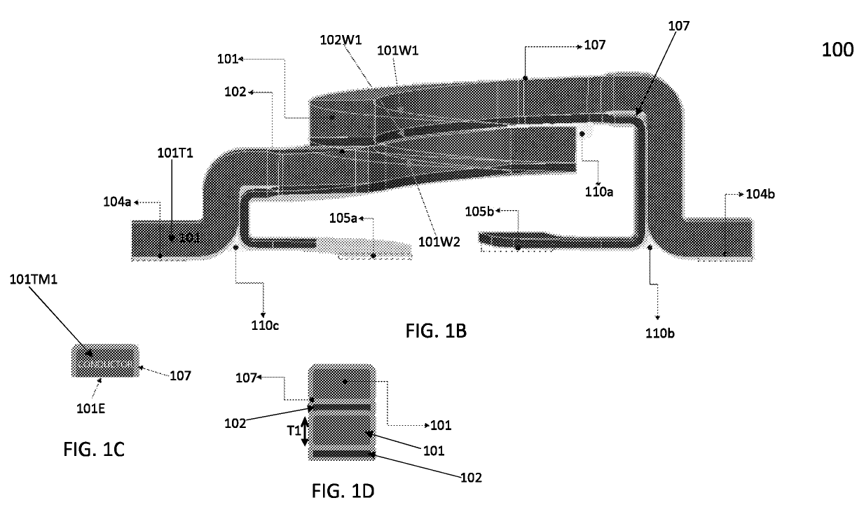

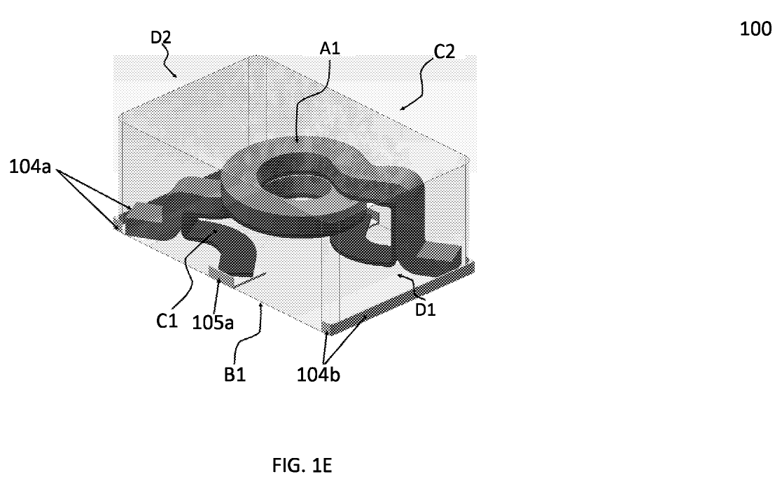

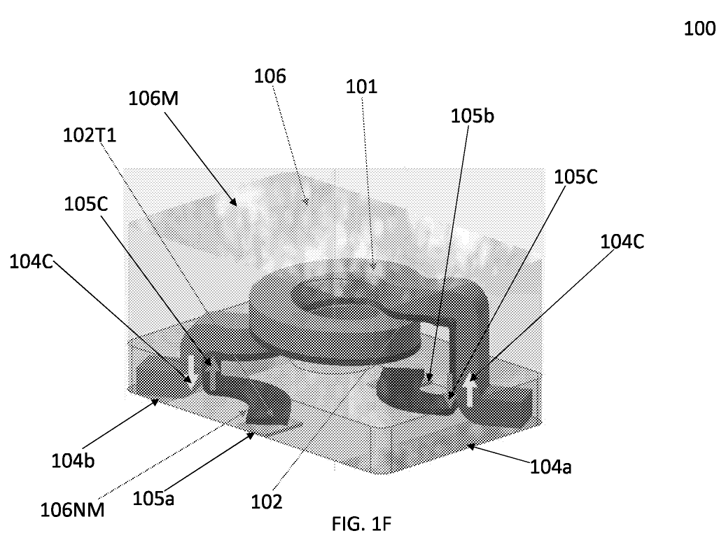

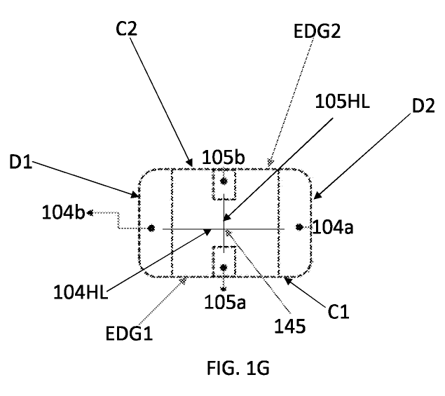

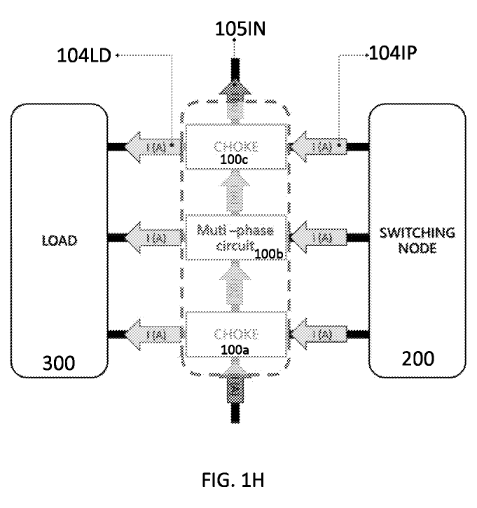

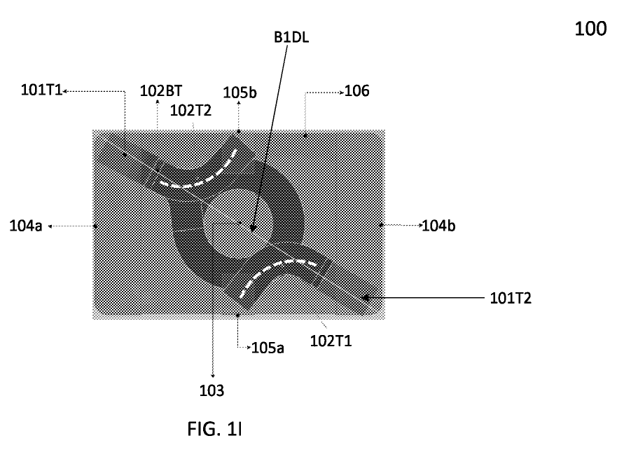

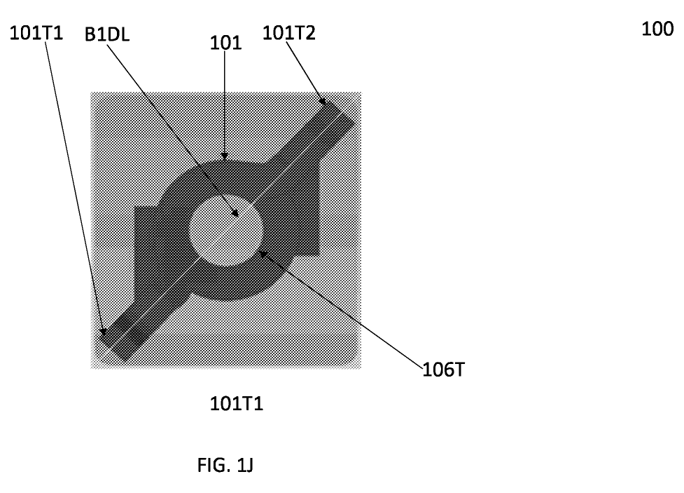

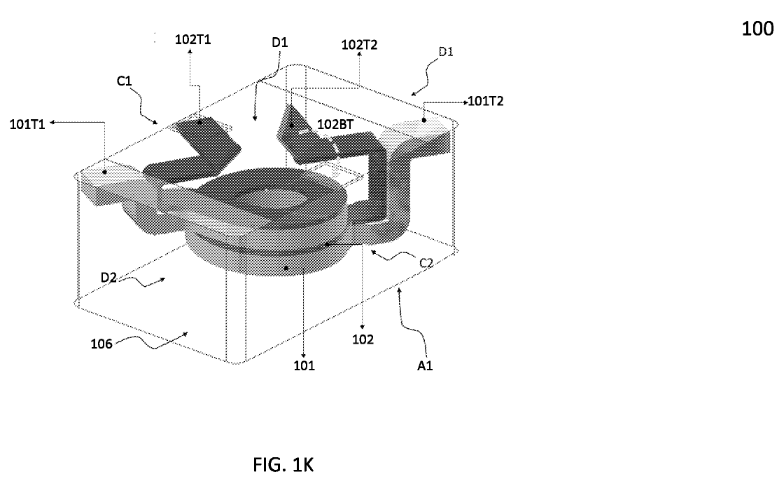

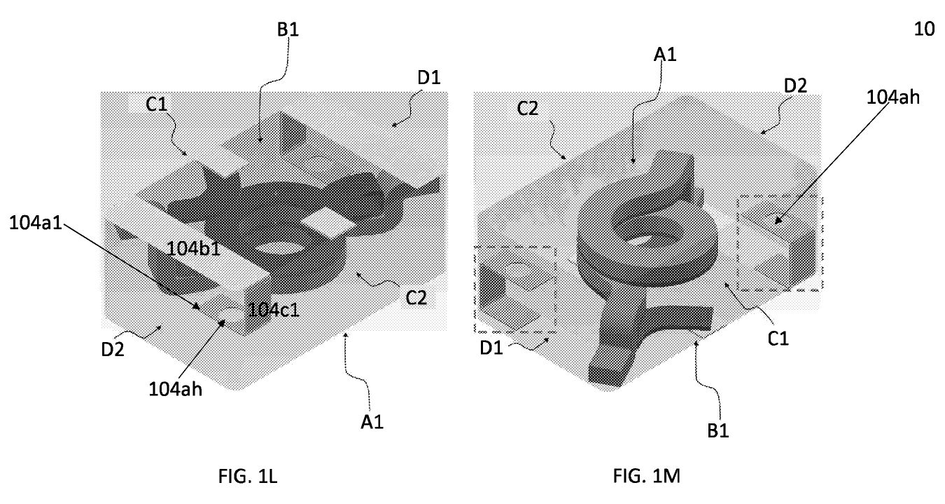

FIG. 1A shows a perspective view of a coupled inductor 100 according to one embodiment of the present invention.

As shown in FIG. 1A, the coupled inductor 100 comprises: a body 106; a first conductive wire 101; and a second conductive wire 102; wherein at least one portion of the first conductive wire 101 and at least one portion of the second conductive wire 102 are disposed inside the body 106; a first electrode 104a, a second electrode 104b, a third electrode 105a, and a fourth electrode 105b, wherein the first electrode 104a, the second electrode 104b, the third electrode 105a, and the fourth electrode 105b are disposed on a first surface, such as a bottom surface B1, of the body 106, wherein the first electrode 104a and the second electrode 104b are electrically connected to the first conductive wire 101, and the third electrode 105a and the fourth electrode 105b are electrically connected to the second conductive wire 102, wherein a first horizontal line segment 104HL passing through the first electrode 104a and the second electrode 104b and a second horizontal line segment 105HL passing through the third electrode 105a and the fourth electrode 105b crosses each other at a location 145 inside the periphery of the first surface, such as the bottom surface B1, of the body 106.

In one embodiment, the first horizontal line segment 104HL and the second horizontal line segment 105HL crosses each other at a location inside the periphery of the top surface A1, of the body 106.

In one embodiment, the first horizontal line segment 104HL is perpendicular to the second horizontal line segment 105HL.

In one embodiment, the first conductive wire 101 comprises a first coil comprising at least one first winding turn, and the second conductive wire 102 comprises a second coil comprising at least one second winding turn, wherein the at least one first winding turn of the first conductive wire 101 and the at least one second winding turn of the second conductive wire 102 are disposed inside the body 106.

In one embodiment, the at least one first winding turn of the first conductive wire 101 and the at least one second winding turn of the second conductive wire 102 are wound around a common axis 103.

In one embodiment, as shown in FIG. 1A, the magnetic body 106 comprises a T core 106T, wherein the first coil and the second coil are wound around a pillar of the T core 106T.

In one embodiment, as shown in FIG. 1A, the first electrode 104a extends from a bottom surface B1 of the body 106 to a first lateral surface D1 of the body 106.

In one embodiment, as shown in FIG. 1A, the second electrode 104b extends from a bottom surface B1 of the body 106 to a second lateral surface D2 of the body 106, wherein the first lateral surface D1 and the second lateral surface D2 are two opposite lateral surfaces of the body 106.

In one embodiment, as shown in FIG. 1A, the third electrode 105a extends from a bottom surface B1 of the body 106 to a third lateral surface C1 of the body 106.

In one embodiment, as shown in FIG. 1A, the fourth electrode 105b from a bottom surface B1 of the body 106 to a fourth lateral surface C2 of the body 106, wherein the third lateral surface C1 and the fourth lateral surface C2 are two opposite lateral surfaces of the body 106.

In one embodiment, each of the first conductive wire 101 and the second conductive wire 102 is a flat wire.

In one embodiment, each of the first conductive wire 101 and the second conductive wire 102 is an enameled wire.

In one embodiment, each of the first conductive wire 101 and the second conductive wire 102 is a flat enameled wire.

In one embodiment, each of the first conductive wire 101 and the second conductive wire 102 is made by a film process.

In one embodiment, as shown in FIG. 1B, an insulating layer 107 is disposed on each of the first conductive wire 101 and the second conductive wire 102.

In one embodiment, as shown in FIG. 1B, an adhesive material 110a is disposed in a space formed by a first winding turn of the first conductive wire 101 and a second winding turn of the second conductive wire 102.

In one embodiment, as shown in FIG. 1B, an adhesive material 110b is disposed in a space formed by a first terminal part of the first conductive wire 101 and a first terminal part of the second conductive wire 102.

In one embodiment, as shown in FIG. 1B, an adhesive material 110c is disposed in a space formed by a second terminal part of the first conductive wire 101 and a second terminal part of the second conductive wire 102.

In one embodiment, as shown in FIG. 1C, a terminal part 101T1 of the first conductive wire 101 is encapsulated by the insulating layer 107 with a surface 101E of the internal conductor 101TM1 of the terminal part 101T1 of the first conductive wire is exposed for forming the first electrode 104a.

In one embodiment, as shown in FIG. 1D, a first thickness T1 of the first conductive wire 101 is greater than a second thickness of the second conductive wire 102.

In one embodiment, a first width of the first conductive wire is substantially equal to a second width of the second conductive wire.

In one embodiment, as shown in FIG. 1D, a first portion 102W1 of the at least one second winding turn of a second conductive wire 102 is disposed between a second portion 101W1 of the at least one first winding turn of the first conductive wire 101 and a third portion 101W2 of the at least one first winding turn of the first conductive wire 101.

In one embodiment, as shown in FIG. 1D, said first portion 102W1, said second portion 101W1 and said third portion 101W2 are stacked along a vertical direction.

In one embodiment, the body 106 is a magnetic body.

In one embodiment, an insulating layer 108 is disposed on the outer surface of the magnetic body 106.

In one embodiment, the insulating layer 108 comprises epoxy.

In one embodiment, as shown in FIG. 1E, the first electrode 104a extends from a bottom surface B1 of the body 106 to a first lateral surface D1 of the body 106, wherein the outer surface of the first electrode 104a comprises Sn.

In one embodiment, as shown in FIG. 1E, the second electrode 104b extends from a bottom surface B1 of the body 106 to a second lateral surface D2 of the body 106, wherein the outer surface of the second electrode 104b comprises Sn.

In one embodiment, as shown in FIG. 1E, the third electrode 105a extends from a bottom surface B1 of the body 106 to a third lateral surface C1 of the body 106, wherein the outer surface of the third electrode 105a comprises Sn.

In one embodiment, as shown in FIG. 1E, the fourth electrode 105b extends from a bottom surface B1 of the body 106 to a fourth lateral surface C2 of the body 106, wherein the outer surface of the fourth electrode 105b comprises Sn.

In one embodiment, as shown in FIG. 1F, a first current 104C flowing through the first coil of the first conductive wire 101 induces a second current 105C flowing through the second coil of the second conductive wire 102.

In one embodiment, as shown in FIG. 1F, the at least one first winding turn of the first conductive wire 101 and the at least one second winding turn of the second conductive wire 102 are encapsulated by a magnetic portion 106M of the body 106, and a first terminal part of the second conductive wire 102T1 is encapsulated by a first non-magnetic portion 106NM of the body 106.

In one embodiment, the at least one first winding turn of the first conductive wire 101 and the at least one second winding turn of the second conductive wire 102 are encapsulated by a magnetic portion 106M of the body 106, and a second terminal part of the second conductive wire is encapsulated by a second non-magnetic portion of the body 106.

In one embodiment, as shown in FIG. 1G, the first electrode 104a extends from a bottom surface B1 of the body 106 to a first lateral surface D1 of the body 106.

In one embodiment, as shown in FIG. 1G, the second electrode 104b extends from a bottom surface B1 of the body 106 to a second lateral surface D2 of the body 106, wherein the first lateral surface D1 and the second lateral surface D2 are two opposite lateral surfaces of the body 106.

In one embodiment, as shown in FIG. 1G, the third electrode 105a extends from a bottom surface B1 of the body 106 to a third lateral surface C1 of the body 106.

In one embodiment, as shown in FIG. 1I, the fourth electrode 105b from a bottom surface B1 of the body 106 to a fourth lateral surface C2 of the body 106, wherein the third lateral surface C1 and the fourth lateral surface C2 are two opposite lateral surfaces of the body 106.

In one embodiment, as shown in FIG. 1G, the first electrode 104a extends from a first edge EDG1 to a second edge EDG2 of the bottom surface of the body.

In one embodiment, as shown in FIG. 1G, the second electrode 104b extends from the first edge EDG1 to the second edge EDG2 of the bottom surface of the body 106, wherein the first edge and the second edge are two opposite edges of the bottom surface of the body 106.

In one embodiment, as shown in FIG. 1G, the third electrode 105a is disposed along the first edge EDG1 of the bottom surface of the body 106 and located between the first electrode 104a and the second electrode 104b.

In one embodiment, as shown in FIG. 1G, the fourth electrode 105b is disposed along the second edge EDG2 of the bottom surface of the body 106 and located between the first electrode 104a and the second electrode 104b.

In one embodiment, as shown in FIG. 1G, the first electrode 104a and the second electrode 104b are electrically connected to the first conductive wire 101, and the third electrode 105a and the fourth electrode 105b are electrically connected to the second conductive wire 102, wherein two end points of a first horizontal line segment 104HL are respectively passing through the first electrode 104a and the second electrode 104b; and two end points of a second horizontal line segment 105HL are respectively passing through the third electrode 105a and the fourth electrode 105b, wherein the first horizontal line segment 104HL and the second horizontal line segment 105HL crosses each other at a location 145 inside the periphery of the first surface such as the bottom surface B1 of the body 106.

In one embodiment, as shown in FIG. 1G, the first horizontal line segment 104HL is perpendicular to the second horizontal line segment 105HL.

In one embodiment, as shown in FIG. 1H, multiple coupled inductors 100a, 100b, 100c can be connected in series, wherein an inputs current 104IP from a switching node 200 is flowing through the first electrode 104a and the second electrode 105a, and an output current 104LD is generated and inputted to the load device 300, wherein the induced current 105IN generated by the coupled inductors 100a, 100b, 100c is flowing through in a direction to make the layout of the circuit much easier for routing wires.

In one embodiment, as shown in FIG. 1I, the first electrode 104a extends from a first edge EDG1 to a second edge EDG2 of the bottom surface of the body, wherein a first terminal part 101T1 of the first conductive wire 101 and a second terminal part 101T2 of the first conductive wire 101 are placed in two diagonal corners of the bottom surface of the body, wherein a diagonal line B1DL passes the first terminal part 101T1 and the second terminal part 101T2 of the first conductive wire 101 .

In one embodiment, as shown in FIG. 1I, the second electrode 104b extends from the first edge EDG1 to the second edge EDG2 of the bottom surface of the body, wherein the first edge and the second edge are two opposite edges of the bottom surface of the body.

In one embodiment, as shown in FIG. 1I, the third electrode 105a is disposed along the first edge EDG1 of the bottom surface of the body and located between the first electrode 104a and the second electrode 104b.

In one embodiment, as shown in FIG. 1I, the fourth electrode 105b is disposed along the second edge EDG2 of the bottom surface of the body and located between the first electrode 104a and the second electrode 104b.

In one embodiment, as shown in FIG. 1I, a terminal part 102T2 of the second conductive wire 102 is bending from a portion 102BT to the fourth electrode 105b.

In one embodiment, as shown in FIG. 1I, a terminal part 102T1 of the second conductive wire 102 is bending to the third electrode 105a.

In one embodiment, as shown in FIG. 1I, the first electrode 104a extends from a first edge EDG1 to a second edge EDG2 of the bottom surface of the body, wherein a first terminal part 101T1 of the first conductive wire 101 and a second terminal part 101T2 of the first conductive wire 101 are placed in two diagonal corners of the bottom surface of the body.

In one embodiment, as shown in FIG. 1J, the second electrode 104b extends from the first edge EDG1 to the second edge EDG2 of the bottom surface of the body, wherein the first edge and the second edge are two opposite edges of the bottom surface of the body.

In one embodiment, as shown in FIG. 1K, the first electrode 104a extends from a first edge EDG1 to a second edge EDG2 of the bottom surface of the body, wherein a first terminal part 101T1 of the first conductive wire 101 and a second terminal part 101T2 of the first conductive wire 101 are placed in two diagonal corners of the bottom surface of the body.

In one embodiment, as shown in FIG. 1K, a first terminal part 102T1 of the second conductive wire 101 and a second terminal part 102T2 of the second conductive wire 101 are bending to the locations of the third electrode 105a and the fourth electrode 105b.

In one embodiment, as shown in FIG. 1L, a first lead is embedded inside the body with at least one portion of the lead exposed from the bottom surface of the body to form the first electrode.

In one embodiment, as shown in FIG. 1M, a first lead is embedded inside the body with at least one portion of the first lead exposed from the bottom surface of the body to form the first electrode, wherein a first through hole 104ah is formed in the first lead and a portion of the body is disposed in the through hole 104ah, for making the mechanical structure between the first lead and the body stronger.

In one embodiment, as shown in FIG. 1L, a first lead is embedded inside the body with a first portion 104b1 of the lead exposed from the bottom surface of the body to form the first electrode, wherein the first portion 104b1 extends to a second portion 104a1 opposite to the first portion via a third portion 104c1, wherein a first through hole 104ah is formed in the second portion 104a1 of the first lead for allowing the body extending through the first through hole 104ah for making the mechanical structure between the first lead and the body stronger.

In one embodiment, a coupled inductor is disclosed, wherein the coupled inductor comprises: a body; a first coil, comprising at least one first winding turn of a first conductive wire; and a second coil, comprising at least one second winding turn of a second conductive wire; wherein the at least one first winding turn of the first conductive wire and the at least one second winding turn of the second conductive wire are disposed inside the body; a first electrode, a second electrode, a third electrode, and a fourth electrode, wherein the first electrode, the second electrode, the third electrode, and the fourth electrode are disposed on a bottom surface of the body, wherein the first electrode and the second electrode are electrically connected to the first coil, and the third electrode and the fourth electrode are electrically connected to the second coil, wherein a first portion of the first lead is embedded inside the body with said first portion of the lead exposed from the bottom surface of the body to form the first electrode, wherein a second portion of the first lead is embedded inside the body, wherein the second portion of the first lead comprises a through opening and a portion of the body is disposed in the through opening.

In one embodiment, a coupled inductor is disclosed, wherein the coupled inductor comprises: a body; a first coil, comprising at least one first winding turn of a first conductive wire; and a second coil, comprising at least one second winding turn of a second conductive wire; wherein the at least one first winding turn of the first conductive wire and the at least one second winding turn of the second conductive wire are disposed inside the body, wherein a first portion of the at least one second winding turn of a second conductive wire is disposed between a second portion of the first conductive wire and a third portion of the first conductive wire, wherein said first portion, said second portion, and said third portion are stacked along a vertical direction.

In one embodiment, a coupled inductor is disclosed, wherein the coupled inductor comprises: a body, comprising a magnetic portion and a non-magnetic portion; a first coil, comprising at least one first winding turn of a first conductive wire; and a second coil, comprising at least one second winding turn of a second conductive wire; wherein the at least one first winding turn of the first conductive wire and the at least one second winding turn of the second conductive wire are encapsulated by the magnetic portion of the body, and a first terminal part of the second conductive wire is encapsulated by the non-magnetic portion of the body.

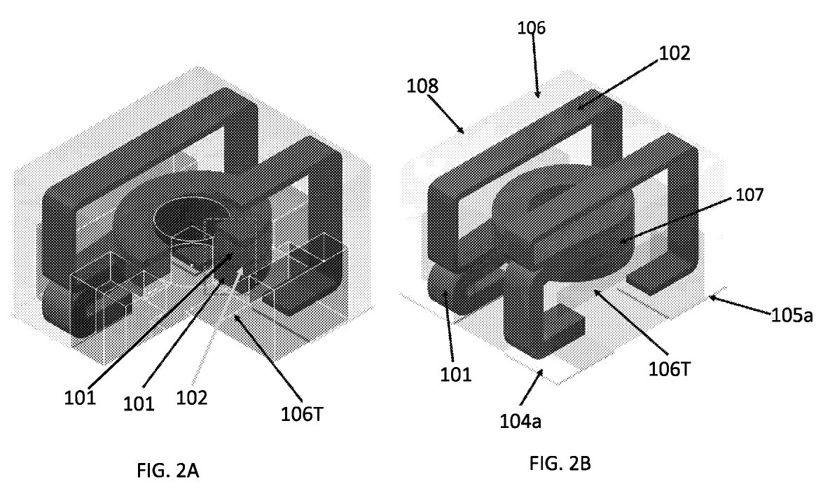

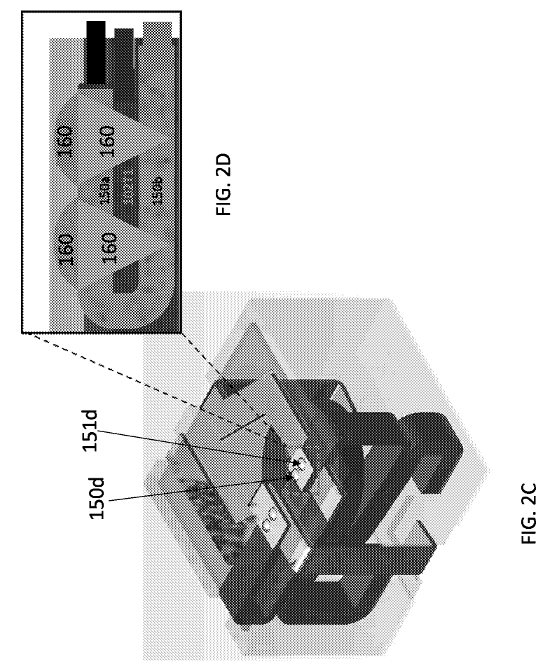

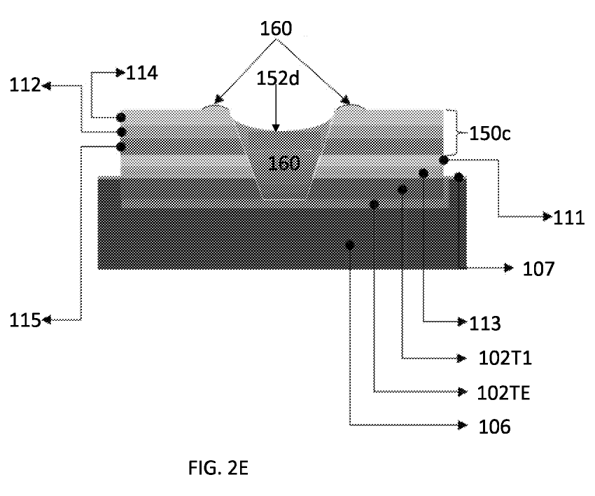

In one embodiment, as shown in FIG. 2A and FIG. 2B, a coupled inductor, comprising: a body; a first coil, comprising at least one first winding turn of a first conductive wire; and a second coil, comprising at least one second winding turn of a second conductive wire; wherein the at least one first winding turn of the first conductive wire and the at least one second winding turn of the second conductive wire are disposed inside the body, wherein a first portion of the at least one second winding turn of a second conductive wire is disposed between a second portion of the first conductive wire and a third portion of the first conductive wire, wherein said first portion, said second portion, and said third portion are stacked along a vertical direction.

In one embodiment, as shown in FIG. 2C, a terminal part of the second conductive wire 102 is disposed between a first portion 150a and a second portion 150b of a first lead, wherein a first through hole 150d is formed in the first lead for making the soldering structure stronger.

In one embodiment, as shown in FIG. 2C, wherein a second through hole 151d is formed in the first lead for making the soldering structure stronger.

In one embodiment, as shown in FIG. 2D, a soldering material 160 is disposed on a top surface of the first portion 150a and extends to a terminal part of the second conductive wire 102T1 and the second portion 150b of a first lead via the first through hole 150d for making the soldering structure stronger.

In one embodiment, as shown in FIG. 2D, a soldering material 160 is disposed on a top surface of the first portion 150a and extends to a terminal part 102T1 of the second conductive wire 102 and the second portion 150b of a first lead via the second through hole 151d for making the soldering structure stronger.

In one embodiment, as shown in FIG. 2E, a soldering material 160 is disposed on a top surface of the first portion 150a of a lead 150c and extends to a terminal part of the second conductive wire 102T1 via the through hole 152d formed in the lead 150c for making the soldering structure stronger.

In one embodiment, as shown in FIG. 2E, the soldering material 160 is can be in contact with an insulation layer 102TE on the bottom surface of the second conductive wire 102T1, wherein the top surface of the internal conductor of the second conductive wire 102T1 is exposed for contacting the soldering material 160.

In one embodiment, as shown in FIG. 2E, the lead 150c comprises a copper layer 115, a first nickel layer 112, and a first tin layer 114, wherein the first nickel layer 112 is disposed on the copper layer 115 and the first tin layer 114 is disposed on the first nickel layer 112.

In one embodiment, as shown in FIG. 2E, a second nickel layer 113 is disposed on the terminal part 102T1 of the second conductive wire 102 and a second tin layer 111 is disposed on the second nickel layer 113, wherein the lead 150c is disposed on the second tin layer 111.

Although the present invention has been described with reference to the above embodiments, it will be apparent to one of ordinary skill in the art that modifications to the described embodiment may be made without departing from the spirit of the invention. Accordingly, the scope of the invention will be defined by the attached claims not by the above-detailed descriptions.

What is claimed is:

1. A coupled inductor, comprising:
a body;
a first coil including at least one first winding turn of a first conductive wire; and
a second coil including at least one second winding turn of a second conductive wire, wherein the at least one first winding turn of the first conductive wire and the at least one second winding turn of the second conductive wire are disposed inside the body, wherein a portion of the at least one second winding turn of the second conductive wire is disposed between a first potion of the at least one first winding turn of the first conductive wire and a second portion of the at least one first winding turn of the first conductive wire, and wherein the portion of the at least one second winding turn of the second conductive wire, the first potion of the at least one first winding turn of the first conductive wire, and the second portion of the at least one first winding turn of the first conductive wire are stacked along a vertical direction; and
an insulating layer disposed on each of the first conductive wire and the second conductive wire,
wherein at least one portion of the first conductive wire and at least one portion of the second conductive wire are stacked together with the insulating layer along the vertical direction, and the insulating layer interfaces each of the at least one portion of the first conductive wire and the at least one portion of the second conductive wire.

2. The coupled inductor according to claim 1, wherein the at least one first winding turn of the first conductive wire and the at least one second winding turn of the second conductive wire are encapsulated by a magnetic portion of the body, and a first terminal part of the second conductive wire is encapsulated by a non-magnetic portion of the body.

3. The coupled inductor according to claim 1, wherein the body includes a magnetic body, the magnetic body includes a T core, and the first coil and the second coil are wound around a pillar of the T core.

4. The coupled inductor according to claim 1, further comprising a first electrode, a second electrode, a third electrode, and a fourth electrode disposed on a surface of the body, wherein the first electrode and the second electrode are electrically connected to the first conductive wire, and the third electrode and the fourth electrode are electrically connected to the second conductive wire, and wherein a first horizontal line segment passing through the first electrode and the second electrode and a second horizontal line segment passing through the third electrode and the fourth electrode cross each other at a location inside a periphery of the surface of the body, and the first horizontal line segment is perpendicular to the second horizontal line segment.

5. The coupled inductor according to claim 1, wherein each of the first conductive wire and the second conductive wire is a flat wire.

6. The coupled inductor according to claim 1, wherein each of the first conductive wire and the second conductive wire is an enameled wire.

7. The coupled inductor according to claim 1, wherein each of the first conductive wire and the second conductive wire is made by a film process.

8. The coupled inductor according to claim 1, wherein an adhesive material is disposed in a space formed by a first winding turn of the first conductive wire and a second winding turn of the second conductive wire.

9. The coupled inductor according to claim 4, wherein the surface of the body is a bottom surface of the body, and a lead is embedded inside the body with at least one portion of the lead exposed from the bottom surface of the body to form the first electrode.

10. The coupled inductor according to claim 9, wherein a through hole is formed in the lead, and a portion of the body is disposed inside the through hole.

11. A coupled inductor, comprising:
a body including a magnetic portion and a non-magnetic portion;
a first coil including at least one first winding turn of a first conductive wire;
a second coil including at least one second winding turn of a second conductive wire, wherein the at least one first winding turn of the first conductive wire and the at least one second winding turn of the second conductive wire are encapsulated by the magnetic portion of the body, and a first terminal part of the second conductive wire is encapsulated by the non-magnetic portion of the body; and
an insulating layer disposed on each of the first conductive wire and the second conductive wire,
wherein at least one portion of the first conductive wire and at least one portion of the second conductive wire are stacked together with the insulating layer along a vertical direction, and the insulating layer interfaces each of the at least one portion of the first conductive wire and the at least one portion of the second conductive wire.

12. The coupled inductor according to claim 11, wherein the body includes a magnetic body, the magnetic body includes a T core, and the first coil and the second coil are wound around a pillar of the T core.

13. The coupled inductor according to claim 11, further comprising a first electrode, a second electrode, a third electrode, and a fourth electrode disposed on a surface of the body, wherein the first electrode and the second electrode are electrically connected to the first conductive wire, and the third electrode and the fourth electrode are electrically connected to the second conductive wire, and wherein a first horizontal line segment passing through the first electrode and the second electrode and a second horizontal line segment passing through the third electrode and the fourth electrode cross each other at a location inside a periphery of the surface of the body, and the first horizontal line segment is perpendicular to the second horizontal line segment.

14. The coupled inductor according to claim 11, wherein each of the first conductive wire and the second conductive wire is a flat wire.

15. The coupled inductor according to claim 11, wherein each of the first conductive wire and the second conductive wire is an enameled wire.

16. The coupled inductor according to claim 11, wherein each of the first conductive wire and the second conductive wire is made by a film process.

17. The coupled inductor according to claim 11, wherein an adhesive material is disposed in a space formed by a first winding turn of the first conductive wire and a second winding turn of the second conductive wire.

18. The coupled inductor according to claim 13, wherein the surface of the body is a bottom surface of the body, and a lead is embedded inside the body with at least one portion of the lead exposed from the bottom surface of the body to form the first electrode.

19. The coupled inductor according to claim 18, wherein a through hole is formed in the lead, and a portion of the body is disposed inside the through hole.
